(19) United States
(12) Patent Application Publication
(10) Pub. No.: US 2007/0107198 A1
(43) Pub. Date: May 17, 2007

(54) Method for position indexing of a machine or similar on the floor and machine leg used therefor

(76) Inventors: Jean-Philippe Ol, Vaureal (FR); Francois Malatier, Taverny (FR)

Correspondence Address: YOUNG & THOMPSON, 745 SOUTH 23RD STREET, 2ND FLOOR, ARLINGTON, VA, 22202, US

(21) Appl. No.: 10/576,016

(22) PCT Filed: Oct. 11, 2004
(86) PCT No.: PCT/FR04/02568

§ 371 Date: Apr. 17, 2006

(30) Foreign Application Priority Data
Oct. 17, 2003 (FR) 0312153

(51) Int. Cl. B23P 11/00

(52) U.S. Cl. 29/525.01

(57) ABSTRACT

Method of indexing a machine or the like in position on the ground, the machine having a leg with a hollow bushing (104) for adjusting its level, which bushing is screwed to the machine and bears without sliding on a soleplate (102) in contact with the ground, the soleplate including an orifice (106) opening out into the bushing. The method includes the steps of positioning the machine on the ground, of drilling a hole (112) in the ground in line with the orifice (106) in the soleplate (102) using a drilling tool passing along the bushing (104) and through the orifice (106) in the soleplate, and of fitting in the hole a positioning member (107) that co-operates with the orifice (106) in the soleplate in order to index its position on the ground. A machine leg specially adapted to implementing the method is also disclosed.

The invention relates to a method of indexing the position on the ground of a machine or the like, such as a machine tool or a welding robot, and it also relates to a machine leg used therefor.

### BACKGROUND OF THE INVENTION

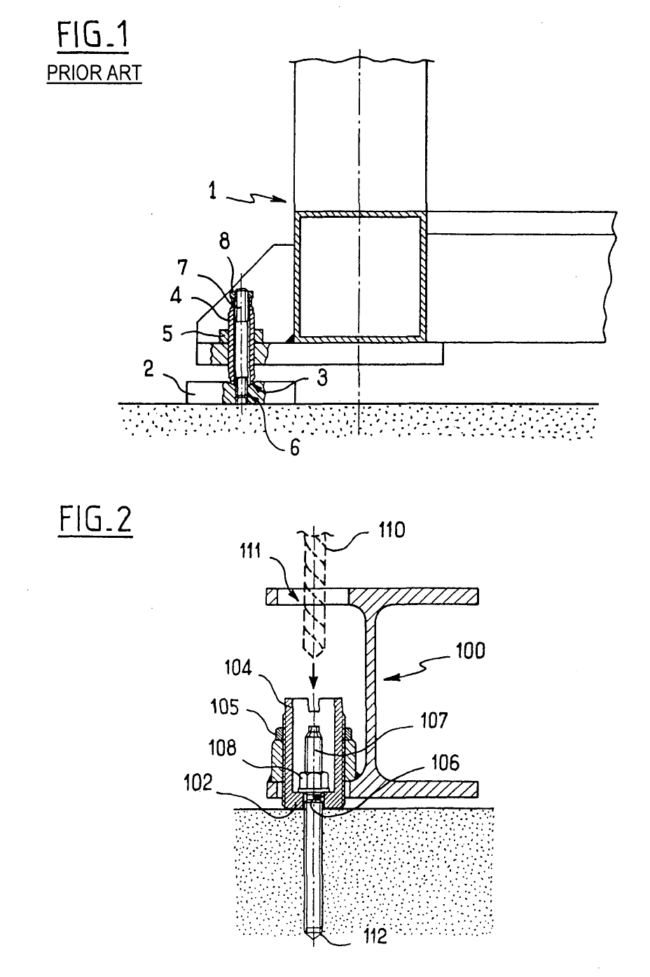

A machine leg in accordance with the prior art is shown in section in accompanying FIG. 1.

The machine 1 comprises a frame with a stand that rests on the ground, generally a concrete floor, via legs such as the leg shown which includes a bushing 4 screwed to the stand of the machine and projecting beneath it.

The bushing 4 has a bottom end which is received in a conical recess 3 in a soleplate 2 secured to the ground by fastener screws (not shown) and serving to distribute pressure over the ground in order to avoid indenting it.

The bushing 4, once it has been screwed in or out so as to adjust the level of the machine properly, is itself locked in position on the stand on the machine 1 by means of a lock nut 5.

Under the effect of the weight of the machine 1, co-operation between the bottom end of the bushing 4 and the conical recess 3 in the soleplate 2 ensures that the axis of the bushing 4 is automatically brought into alignment with the axis of the conical recess 3, thereby indexing the position of the machine 1 on the ground.

The soleplate 2 has a tapped orifice 6 in the centre of the conical recess 3 for receiving the end of a tie bar 7 whose other end carries an anchor nut 8 which is tightened against the top end of the bushing 4, thus preventing the machine from moving upwards, e.g. under the effect of vibration or of a weight being moved outside the polygon of support of the machine as a result of a moving portion of the machine making a corresponding movement.

Such a machine leg presents the drawback of requiring access to the soleplate in order to be able to be secured thereto.

As shown in FIG. 1, it is possible, initially, to place the legs under projecting portions of the machine, thereby offsetting the soleplates from the stand and giving easy access to the plates. However, these projecting portions constitute obstacles preventing the stands of adjacent machines being disposed contiguously.

In another disposition, the legs extend directly under the stand, thereby avoiding the above-mentioned drawback. Under such circumstances, since the machine is already fitted with the bushings 4 having the soleplates 2 retained thereto by means of the tie bars 7 and the nuts 8, once the machine has been put into place, it is necessary to identify the positions on the ground of the soleplates, to move the machine while separating the soleplates therefrom, to secure the soleplates to the ground in the previously-identified positions, and to replace the machine 1 in position on the soleplates. That type of installation procedure is lengthy and complex to implement and requires a large amount of handling of the machine by means of hoists of large dimensions adapted to the weight and the size of the machine.

In order to avoid that large amount of handling, it is known to provide a plurality of passages in the stand of the machine, each extending in register with one of the orifices in a soleplate that is to receive a screw for securing it to the ground. These passages make it possible to drill holes in the ground in line with the soleplate orifices that are to receive the fastener screws without it being necessary to move the machine, this being done by means of a drill bit passed via the passage and inserted into the orifice in the soleplate (typically four fastener screws per soleplate, i.e. drilling four holes per soleplate). Nevertheless those numerous passages complicate the design of the machine and weaken it. In addition, while the machine is being positioned, it is essential to ensure that the soleplates do not turn so that the orifices for the fastener screws remain in alignment with the passages through the stand. That method is made difficult to implement by the fact that the fastener screws must be put into position blind in the bottoms of passages that may be of considerable length.

### OBJECT OF THE INVENTION

An object of the invention is to provide a method of indexing the position on the ground of a machine or the like that avoids the above-mentioned drawbacks, and also to provide a machine leg that is specially designed for implementing the method.

### BRIEF SUMMARY OF THE INVENTION

More precisely, the invention provides a method of indexing a machine or the like in position on the ground, the machine having a leg with a hollow bushing for adjusting its level, which bushing is screwed to the machine and bears without sliding on a soleplate in contact with the ground, the soleplate including an orifice opening out into the bushing, the method comprising the steps of positioning the machine on the ground, of drilling a hole in the ground in line with the orifice in the soleplate using a drilling tool passing along the bushing and through the orifice in the soleplate, and of fitting in the hole a positioning member that co-operates with the orifice in the soleplate in order to index its position on the ground.

Unlike known methods, the method of the invention thus requires only one hole to be drilled in order to index the position of the soleplate on the ground, and thus to index the positions of the bushing and of the machine. Since the hole is drilled substantially on the axis of the bushing, it matters little whether or not the soleplate turns during positioning of the machine.

The method of the invention is very simple and quick to implement (one hole drilled per leg), and is does not require the machine to be handled in any way other than being put into its final position.

In a particular implementation of the method of the invention, the positioning member is secured to the ground, preferably by being embedded herein. The fastening of the positioning member to the ground enables it to be used not only as an indexing member, but also as a member for anchoring the machine to the ground, e.g. by engaging an anchoring nut on a threaded end thereof, thereby holding the bushing to the ground.

The invention also provides a machine leg for using the method, the leg comprising a hollow bushing with a sole-forming bottom, the bottom including an orifice for co-operating with a positioning member projecting from the ground.

Like the soleplate, the bottom presents an area that is large enough to transmit the weight of the machine to the ground while imparting a pressure that is acceptable.

In a preferred embodiment, the bottom is made integrally with the bushing.

In a particular disposition, the positioning member is secured to the ground and has a threaded free end for receiving a nut for anchoring the bushing, which nut bears against an inside face of the bottom of the bushing.

### BRIEF DESCRIPTION OF THE DRAWING

The detailed description of the invention made below refers not only to above-described FIG. 1, but also to FIG. 2 which is a section view of a machine leg of the invention, shown after it has been put into place by the method of the invention.

### DETAILED DESCRIPTION OF THE INVENTION

In FIG. 2, the machine 100 includes a stand, with a portion of its structure being visible in the form of an I beam. The stand is fitted with legs such as the leg shown, each comprising a bushing 104 screwed on the bottom flange of the I beam. The bushing 104 has a bottom end presenting a bottom 102 made integrally with the bushing and bearing directly on the ground. The bottom 102 forms a soleplate that is integral with bushing, thus making a saving of one part and avoiding any risk of the soleplate becoming lost or wrongly positioned relative to the bushing while the machine is being put into place. In a variant, the bottom need not be integral with the bushing, but could be fitted thereto so as to be intimately secured therewith, e.g. by means of adhesive or welding. The bottom includes a central orifice 106 opening out into the bushing 104.

The machine 100 provided with its legs is initially put into place on the ground in the desired final position. Once the machine has been positioned, the level of the machine 100 relative to the ground is adjusted by screwing the bushings 104 up or down, and then each of the bushings 104 is locked in position on the machine 100 by means of a lock nut 105.

In accordance with the invention, a hole 112 is then drilled in the ground in line with the orifice 106 by means of a drill bit 110 (drawn in dashed lines) that is inserted into the bushing 104 and the orifice 106. The orifice 106 then acts as a guide for the drill bit 110. For this purpose, the beam of the machine includes a passage 111 through its top flange so as to allow the drill bit 110 to pass therethrough.

It should be observed that if the I beam supports a deck, the deck should also have a passage in register with the bushing 104, the passage through the deck subsequently being closed by a hatch. In order to improve the guidance of the drill bit, it is possible to provide an additional guide associated with the top flange of the I beam.

A tie bar 107 is associated with the hole 112 as drilled in this way, the bar being caused to extend through the orifice 106. The tie bar 107 is secured in the hole 112, e.g. by being embedded therein using an adhesive mortar. Positioning of the tie bar 107 is made easier by the fact that it has a free end that projects a considerable distance from the bottom of the bushing 104 inside the bushing, thus making it easy to hold the tie bar 107 while it is being put into place.

At least level with the orifice 106, the diameter of the tie bar 107 is matched to the diameter of the orifice 106 so that the tie bar 107 acts as a member for positioning the bushing 104 and thus the machine 100, indexing it on the ground in a position as defined by the tie bar 107 itself.

Once the tie bar 107 has been finally embedded, a nut 108 is screwed onto the tapped free end of the tie bar 107 so as to bear against an inside face of the bottom 102, either directly, or as shown via a bearing washer. The tie bar 107 and the nut 108 thus prevent the bushing 104 from moving up from the ground, such that the machine 100 is not only in an indexed position, but it is also anchored to the ground.

It should be observed that the method of the invention can be implemented with the prior art machine leg as shown in FIG. 1. To do this, once a machine fitted with such a leg has been put into position, the nut 8 and the tie bar 7 are removed, a hole is drilled in the ground in line with the orifice 6 in the soleplate 2 by using a drill bit inserted in the bushing 4 and the orifice 6, and a new tie bar, similar to the tie bar 107 of the leg of the invention, is secured in the hole so as to co-operate with the orifice 6 in order to index the position of the soleplate 2 on the ground. Because of the conical co-operation between the soleplate 2 and the bushing 4, indexing the position of the soleplate 2 also leads to the bushing 4 and thus the machine being indexed in position. The new tie bar preferably presents a free end that is threaded and of length that is sufficient to project from the bushing so that a nut for anchoring the bushing can be fitted thereto and can bear against the top end of the bushing 4 in order to anchor the machine on the ground.

The method of the invention can thus be implemented with a bushing that does not have a bottom, whether integral therewith or fitted thereto, even though it is more advantageous, as explained above, to use a bottom that is intimately secured to the bushing.

The tie bar may be secured to the ground by means other than by being embedded therein, for example it may be screwed into a retaining plug fitted in the hole.

If all that is required is to index position without also providing anchoring, then the tie bar can be selected to be of a length that is shorter, but nevertheless long enough to co-operate with the orifice in the soleplate, or in the bottom acting as a soleplate. In these specific conditions, there is no need to secure the tie bar to the ground, it may merely be a sliding fit or force fit in the hole.

1.-6. (canceled)

7. A method of indexing a machine or the like in position on the ground, the machine having a leg with a hollow bushing (4; 104) for adjusting its level, which bushing is screwed to the machine and bears without sliding on a soleplate (2; 102) in contact with the ground, the soleplate including an orifice (6; 106) opening out into the bushing, the method comprising the steps of positioning the machine on the ground, of drilling a hole (112) in the ground in line with the orifice (106) in the soleplate (102) using a drilling tool passing along the bushing (4; 104) and through the orifice (6; 106) in the soleplate, and of fitting in the hole a positioning member (107) that co-operates with the orifice (6; 106) in the soleplate in order to index its position on the ground.

8. A method according to claim 7, including the step of fastening the positioning member (107) in the hole (112) in the ground.

9. A method according to claim 8, wherein the fastening step consists in embedding the positioning member (107) in the ground.

10. A machine leg for implementing the method of claim 7, the leg comprising a hollow bushing (104) with a soleplate-forming bottom (102), the bottom including an orifice (106) for co-operating with a positioning member projecting from the ground.

11. A machine leg according to claim 10, wherein in that the bottom (103) is made integrally with the bushing (104).

12. A machine leg according to claim 10, wherein the positioning member (107) is secured to the ground and has a threaded free end for receiving a nut (108) for anchoring the bushing (104), the nut bearing against an inside face of the bottom of the bushing (104).
